(19) United States
(12) Patent Application Publication
(10) Pub. No.: US 2009/0119138 A1
(43) Pub. Date: May 7, 2009

(54) System and method for managing and presenting information of wedding service providers

(75) Inventor: Kay Kestler, Dallas, TX (US)

Correspondence Address: PATTON BOGGS, LLP, 2001 ROSS AVENUE, SUITE 3000, DALLAS, TX, 75201, US

(73) Assignee: StrictlyWeddings.com LLC

(21) Appl. No.: 11/982,913

(22) Filed: Nov. 6, 2007

(51) Int. Cl. G06Q 30/00

(52) U.S. Cl. 705/7; 705/27

(57) ABSTRACT

One embodiment of a system and method of presenting information of wedding service providers to wedding planners may include investigating wedding service providers of a selected service category. At least three of the wedding service providers may be determined to qualify as meeting a product quality threshold for the selected wedding service category. Information of three of the wedding service providers for the selected wedding service category may be displayed from which a wedding planner may select in planning a wedding.

### BACKGROUND

Weddings are typically one of the most precious and special occasions of peoples' lives. A wedding is the defining event of a couple's future lives together, and one in which the couple's family and friends join together to honor and celebrate the matrimony of a bride and groom. Although a wedding is a very special and joyous occasion, planning a wedding can often be a daunting task for non-professional wedding planners, such as the bride.

Although professional wedding planners exist, many brides take on the role of planning her wedding. The bride often has her mother, siblings, friends, or even mother-in-law assist with the wedding planning. However, since a bride and her assistants are not typically professional wedding planners, their ability to select wedding service providers for the wedding is typically conducted through word of mouth, reviewing yellow page listings, performing Internet searching, reviewing wedding dedicated websites, and so forth. There are inherent problems with planning a wedding using such techniques. For example, word of mouth recommendations from other former brides, friends, or relatives generally results in recommendations that may be out-of-date, recommendations that are subjective to an unsophisticated person in terms of understanding quality of wedding service providers, and recommendations that may be limited from a broad market research perspective. As another example, using the Internet to perform a search for each aspect of a wedding, such as wedding cakes, wedding halls, wedding bands, wedding photographers, wedding videographers, etc., may result in an overwhelming number of search results for each aspect, thereby being vastly time consuming to review and consider each search result. Furthermore, the non-professional wedding planner will have to interview each search result, which may be presented in a non-specific order or in an order based on the ability of the wedding service providers to cause their website to be presented first as opposed to quality. Still yet, while there are many wedding websites, these websites are basically advertising portals that provide wedding service providers with the ability to advertise on the websites. These wedding websites allow as many wedding service providers to advertise as will pay for the advertising space, thereby causing the website to become little more than a yellow pages lookup or Internet search. It should be understood that while professional wedding planners have better connections and understanding of the wedding marketplace, they too have difficulties keeping up with changes of personnel in wedding venues and of other wedding service providers.

As a result of the inefficiencies of existing techniques for wedding planners to plan a wedding, much time, effort, and money is spent to find the best wedding service providers. Moreover, the wedding service providers may not provide a product or service that meets a quality level expected by the wedding planner or guests.

### SUMMARY

To overcome the problems and inefficiencies of existing techniques for wedding planners to plan a wedding, the principles of the present invention provide for a website that presents three wedding service providers that meet a product quality threshold for each wedding service category. By presenting three wedding service providers that meet a product quality threshold, the wedding planners have choices of known quality from which to select, but not so many that the selection process becomes overly time consuming and inefficient.

One embodiment of a method of presenting information of wedding service providers to wedding planners may include investigating wedding service providers of a selected service category. At least three of the wedding service providers may be determined to qualify as meeting a product quality threshold for the selected wedding service category. Information of three of the wedding service providers for the selected wedding service category may be displayed to enable a wedding planner to select from in planning a wedding.

One embodiment of a system for presenting information of wedding service providers to wedding planners may include a database configured to store information records of wedding service providers, where the information records may include investigation results of the wedding service providers and a service category for which the wedding service providers provide services. A processing unit may be in communication with the database, and be configured (i) to determine that at least three of the wedding service providers stored in the database qualify as meeting a product quality threshold for respective wedding service categories and (ii) to display information records of three of the wedding service providers for a selected wedding service category to enable a wedding planner to select from in planning a wedding.

### BRIEF DESCRIPTION OF THE DRAWINGS

Illustrative embodiments of the present invention are described in detail below with reference to the attached drawing figures, which are incorporated by reference herein and wherein:

FIGS. 1A and 1B are illustrations of an exemplary map showing geographic locations in which a wedding service provider auditor/presenter operates to investigate wedding service providers in respective geographic locations;

FIG. 2 is an illustration of a wedding market in which a wedding service provider auditor/presenter, wedding service providers, and wedding parties are located;

FIG. 3 is a block diagram of a computing unit configured to support managing information of wedding service providers to enable wedding planners to view and select the information;

FIG. 4 is a screen shot of an exemplary webpage available for wedding planners to select from a list of wedding planning categories to view wedding service providers;

FIG. 5 is a screen shot of an exemplary webpage available for wedding planners to view and select from three wedding service providers;

FIG. 6 is a screen shot of an exemplary webpage available for wedding planners to view information of a selected wedding service provider; and

FIG. 7 is a flow chart of an exemplary process of a wedding service provider auditor/presenter to manage and present information of wedding service providers in accordance with the principles of the present invention.

### DETAILED DESCRIPTION OF THE DRAWINGS

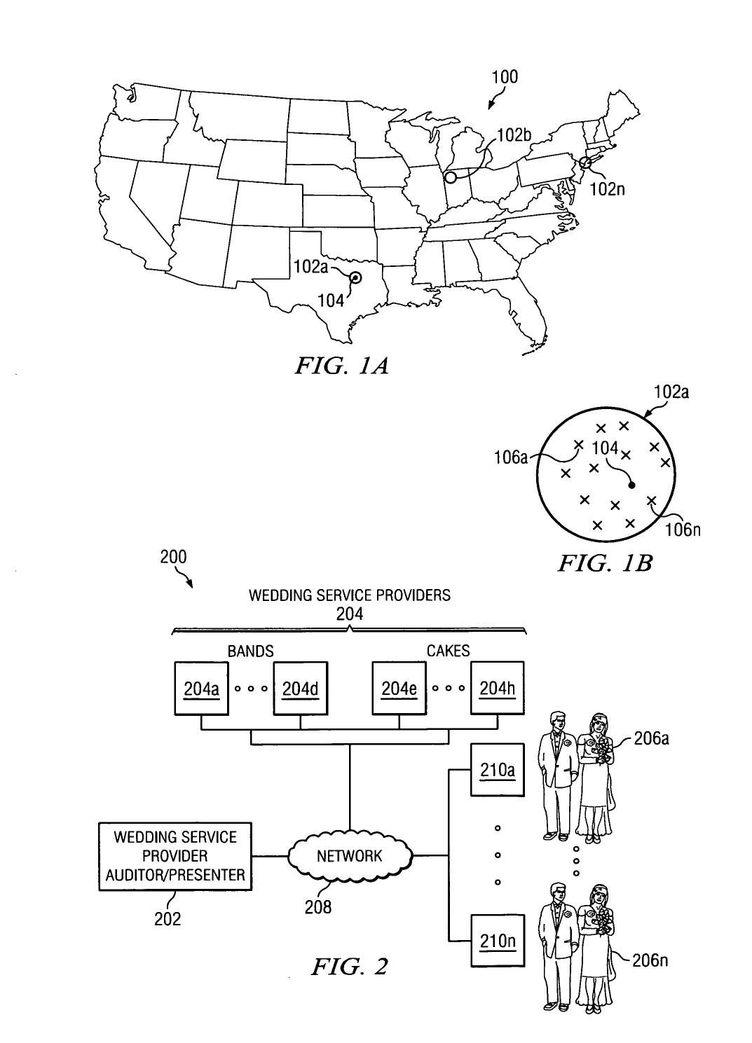

FIGS. 1A and 1B are illustrations of an exemplary map 100 showing geographic locations 102a-102n (collectively 102) in which a wedding service provider auditor/presenter (hereinafter “wedding service provider auditor”) 104 operates to investigate or audit wedding service providers 106a-106n (collectively 106) and 108a-108n (collectively 108) in respective geographic locations. The wedding service provider auditor 104 may be located in a single location, such as Dallas, Tex. and operate to audit or investigate wedding service providers 106 in one or more of the geographic locations 102. Investigation of wedding service providers 106 may include visiting a facility of a wedding service provider and wedding function to determine product quality of the wedding service provider. During the visit, the wedding service provider auditor 104, which may include an employee, representative, third-patty, or other person affiliated with the wedding service provider auditor 104, may review different categories of the wedding service provider in determining product quality, where product quality in considered to include both physical products (e.g., wedding cake, flowers, napkins, wedding invitations, etc.) produced by the wedding service providers 106 and services (e.g., customer service, music quality, guest relations and services, etc.) provided by the wedding service providers 106. For the purposes of this description, products and services produced or provided by wedding service providers are considered “products” of the wedding service providers. The investigation may review may different predetermined quality parameters established to assess an overall quality of a wedding service provider. By determining an overall quality of the wedding service providers, the wedding service provider auditor 104 may determine wedding service providers 106 that provide a product quality that is above a product quality threshold. The wedding service providers 106 that meet the product quality threshold may be presented to wedding planners, such as non-professional wedding service providers (e.g., bride and groom), who are customers or otherwise visitors of a website of the wedding service provider auditor 104.

The map 100, which is of the United States, provides geographic regions 102 in which the wedding service provider auditor 104 operates. Because people getting married are generally interested in wedding service providers in the geographic region in which their weddings are to occur, the wedding service provider auditor 104 may limit presentation of wedding service providers determined to meet the product quality threshold to be presentable to wedding planners, which generally include those getting married.

FIG. 1B is an illustration of an exemplary geographic location 102a defined as a circle. The circle may be formed of a radius about a central location, such as a city center (e.g., Dallas), in which wedding service providers are located. Alternatively, the geographic location 102a may be defined by a town, city, county, or state perimeter. It should be understood that the geographic location may be defined in any manner in which the wedding service provider auditor 104 investigates wedding service providers 106 to consider to present on a website or otherwise (e.g., printed publication). In one embodiment, the wedding service providers 106 may be limited to being presented within the geographic location 102a to ensure local wedding service providers for local weddings. A wedding planner may select a geographic location, such as Dallas, Tex., to view wedding service providers 106 that are investigated by the wedding service provider auditor 104, meet a product quality threshold, and are within the selected geographic location.

FIG. 2 is an illustration of a wedding market 200 in which a wedding service provider auditor/presenter 202, multiple wedding service provider categories of wedding service providers 204, including wedding service providers 204a-204d and 204e-204h (collectively 204), and wedding planners 206a-206n (collectively 206), in this case the brides and grooms, are located and may be in communication via a network 208 using network access devices 210a-210n (collectively 210). In one embodiment, the network 208 is the Internet and the wedding service provider auditor/presenter 202 operates a website (not shown) that is available on the network access devices 210 (e.g., computers) via the network 208 for the wedding planners 206 to access in planning a wedding. The wedding service providers 204 may include as many different wedding service providers is as many different wedding service categories as desired by the wedding service provider auditor/presenter 202. However, although there may be more than three wedding service providers in each wedding service provider category, the wedding service provider auditor/presenter 202 may limit the number of wedding service providers to three, as three provides sufficient choice to wedding planners, but not too many to be difficult to make a selection. By limiting the number of wedding service providers to display in each wedding service provider category, the wedding planners 206 are provided with a limited selection, thereby making selection of wedding service providers efficient for the wedding planners 206. In addition, the artificially limited number of wedding service providers that are displayed maintains a limited level of supply, which results in a naturally high demand for the wedding service providers 204 that desire to be presented on the website.

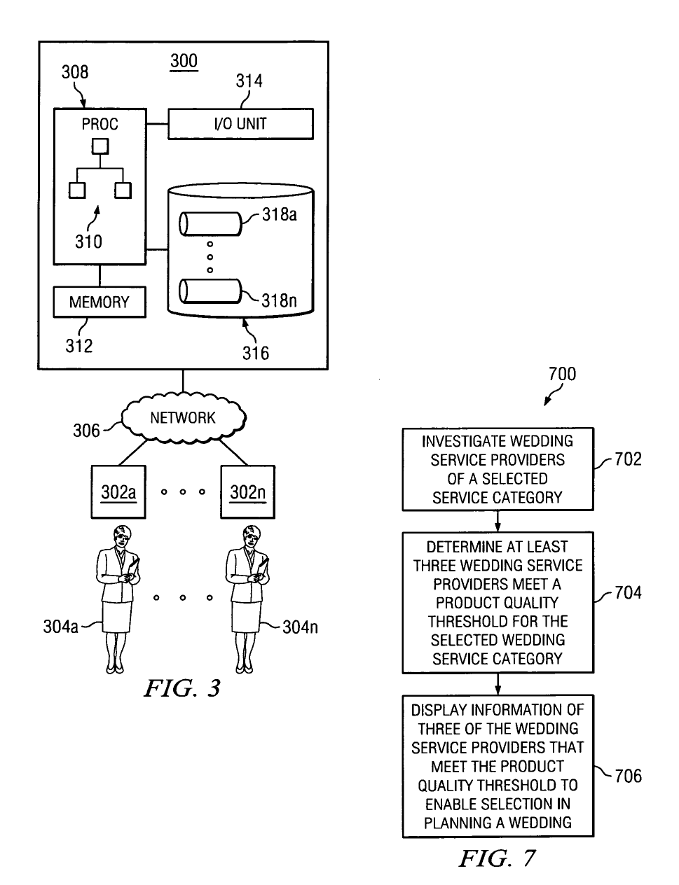

FIG. 3 is a block diagram of a computing unit 300 configured to support managing information of wedding service providers to enable network access devices 302a-302n (collectively 302) operated by wedding planners 304a-304n (collectively 304) to view and select the information via network 306. The computing unit 300 may be a computer server that includes a processing unit 308 having one or more computer processors that execute software 310. The processing unit may be in communication with memory 312, input/output (I/O) unit 314, and storage unit 316 having one or more databases 318a-318n (collectively 318) stored thereon.

The software 310 may operate to manage information of wedding service providers (not shown) being stored on databases 318. The information stored in the databases may include information generated from investigations by a wedding service provider auditor/presenter that investigates wedding service providers. For example, the wedding service provider auditor/presenter may define predetermined quality parameters for each category and assign a grade or rating for each of the predetermined quality parameters during an investigation. The predetermined quality parameters and ratings for each wedding service provider may be stored in records in the databases 318. The software 310 may further be configured to generate a value, such as an average, weighted average, rating, or other statistical value that may be used to determine quality of the wedding service providers based on the grades or other values assigned to each of the predetermined quality parameters. The grades may be letter grades (e.g., A+, A, A−, B+, B, B−) or numeric grades between 1 and 5, 1 and 10, or 1 and 100, for example.

The memory 312 may store data during execution of the software 310 on the processing unit 308. The I/O unit 314 may operate to enable the processing unit 308 to communicate the information stored in the databases 318 with network access devices 302 for display on a website that may be hosted by the computing system 300 or by a third party hosting service. The information stored in the databases 318 may be displayed on the website in response to wedding planner selectively requesting to display the information. For example, the wedding planner may select a wedding service provider category of wedding cakes and three wedding cake makers may be displayed for the wedding planner to view. The wedding planner may select a link such as a photograph being displayed, and view additional information of the wedding service provider. In one embodiment, the additional information is information provided by the wedding service provider. Alternatively and/or additionally, the information may be information generated by the wedding service provider auditor/presenter to provide the wedding planner with the information from the investigation. Still yet, the information may include reviews or feedback provided by other wedding planners of the wedding service providers to allow others to consider before booking the wedding service providers for a wedding. In one embodiment, the feedback may be used by the wedding service provider auditor/presenter as a factor to consider in performing additional investigations or in determining whether the wedding service providers meets a product quality threshold that allows the wedding service providers to be displayed on the website.

TABLE I shows an exemplary list of predetermined parameters for analyzing a wedding service provider in a hotel category and ratings associated with each of the predetermined parameters. The predetermined parameters may be selected to help a wedding planning in knowing what factors determine “class” of a hotel, for example. As shown, the list of predetermined parameters may include tangible and non-tangible items.

The tangible items or parameters may include items that are tangible that one touches or sees. For example, tangible items may include function room space, function rooms views, function rooms lighting, dance floor size, function rooms audio quality, hotel rooms towels, hotel rooms size, hotel rooms showers, parking prices, lobby furniture style, or any other tangible item that the wedding service provider auditor/presenter determines would be benefit a wedding planner in making a decision as to whether the hotel is one in which he or she would be interested in planning a wedding.

The intangible items or parameters may include items that are not touched or seen, but rather causes an emotion or feeling within a person. Although subjective, an investigator from the wedding service provider auditor/presenter investigating a wedding service provider may apply a grade to intangible items. The intangible items may include front desk welcoming quality, staff friendliness, staff professionalism, staff responsiveness, hotel ambience, hotel lobby comfort, hotel rooms style, function rooms style, function rooms class, bridal suite quality, and any other non-tangible parameters that the wedding service provider auditor/presenter may deem relevant in assessing hotels. It should be understood that the list provided is exemplary and that any list of parameters or factors in assessing the quality of a hotel in hosting a wedding may be included.

In one embodiment, a graphical user interface may enable an investigator to input grades or values of product quality for each wedding category of which the wedding service providers are being investigated and graded. The graphical user interface may be web-based or local to a computing system that is managing the databases, such as computing system 300, as understood in the art.

TABLE I
Predetermined Parameters for Hotel Audit

| Tangible Parameter | Rating | Intangible Parameter | Rating |
|---|---|---|---|
| Function room space | 5 | Front desk welcoming | 5 |
| | | quality | |
| Function rooms view | 4.5 | Staff friendliness | 4.5 |
| Function rooms lighting | 5 | Staff professionalism | 5 |
| Dance floor size | 4 | Staff responsiveness | 5 |
| Function room audio quality | 4.5 | Hotel ambience | 5 |
| Hotel rooms towels quality | 5 | Hotel lobby comfort | 4.5 |
| Hotel rooms size | 4.5 | Hotel rooms style | 4.5 |
| Hotel rooms showers | 4.5 | Function rooms style | 5 |
| Parking prices | 4 | Function rooms class | 5 |
| Lobby furniture style | 5 | Bridal suite quality | 4.5 |

TABLE II shows a portion of a database of information of wedding service providers. The information may enable the wedding service provider auditor/presenter to manage categories for each wedding service provider, relative price range of services offered by the wedding service providers, ratings generated by the inspections of the wedding service providers, whether or not a wedding service provider's information is currently being displayed, and display expiration, where the display expiration may coincide with an expiration of a contract for the wedding service provider in advertising on the website of the wedding service provider auditor/presenter. The relative price range of services offered by the wedding service providers may enable a wedding planner to select a relative price level he or she desires for each wedding service category so as to be able to view wedding service providers that meet the wedding service provider auditor/presenter's product quality threshold for that relative price range. The product quality threshold may be lower for lower relative price ranges, but the wedding planner should expect that a less costly wedding service provider may provide a lesser quality product. However, by having relative price ranges assigned to each wedding service provider, the wedding planners may spend an amount of money where he or she feels is appropriate for each aspect of the wedding and find the best wedding service providers in the price range. As shown, the relative price ranges may be indicated by different numbers of “$,” where “$$$$” represents the highest price range and “$” represents the least. Other representations, such as dollar ranges, may be utilized in accordance with the principles of the present invention.

In addition, a last audit date may be stored, where the last audit date may indicate the last date that each wedding service provider was audited or investigated by the wedding service provider auditor/presenter. To ensure that each wedding service provider maintains a threshold quality level that the wedding service provider auditor/presenter supports or otherwise endorses, the wedding service provider auditor/presenter may perform an audit or investigation of each wedding service provider on an annual or other timeframe basis. A scheduler or calendar function executed on a computing system, as understood in the art, may be used to notify or remind the wedding service provider auditor/presenter to perform an annual or other timeframe routine audit. By investigating and rating each wedding service provider regularly, and optionally without notifying the wedding service providers, the wedding service provider auditor/presenter may reassure its customers that the quality of the wedding service providers being presented on its website continues to meet a certain quality level over time. In one embodiment, the wedding service providers may be organized in the table alphabetically, by category, by average rating, by those currently being displayed, by display expiration, or any combination thereof.

It should be understood that other wedding service provider information may be stored in the table to further assist the wedding service provider presenter/auditor in managing wedding service providers and website operation. It should further be understood that the table may include as many categories as the wedding service provider auditor/presenter may desire and that as many wedding service providers as may be desired may be stored for each category. Still yet, each wedding service provider may be listed in different categories if the wedding service provider provides more than one service (e.g., wedding cake and party favors). In addition, the table may include (i) wedding service providers that have average ratings above a product quality threshold value that enables the wedding service provider to be presented or displayed on the website and (i) wedding service providers that do not currently meet the product quality threshold value. For example, if the product quality threshold value is 4.75, then Hotels A, B, and C meet the product quality threshold value and Hotels D, E, and F do not. However, all of the hotels may be maintained in the table as the average rating may change over time, thereby enabling those hotels that meet the product quality threshold value to be able to be presented if one that is currently being presented drops below the product quality threshold value or simply decides to stop advertising.

TABLE II
Wedding Service Provider Information

| Wedding Service | | Rel. Price | Avg. | | Display | Last Audit |
|---|---|---|---|---|---|---|
| Provider | Category | Range | Rating | Displayed? | Exp. | Date |
| Hotel A | Hotel | $$$$ | 4.87 | Yes | Jul. 14, 2008 | Jan. 05, 2007 |
| Hotel B | Hotel | $$$$ | 4.78 | Yes | Aug. 14, 2008 | Jan. 05, 2007 |
| Hotel C | Hotel | $$$$ | 4.75 | Yes | Oct. 07, 2008 | Jan. 07, 2007 |
| Hotel D | Hotel | $$$$ | 4.71 | No | — | Jan. 10, 2007 |
| Hotel E | Hotel | $$$ | 4.68 | No | — | Jan. 10, 2007 |
| Hotel F | Hotel | $$$ | 4.61 | No | — | Feb. 01, 2007 |
| Cake Co. A | Cake | $$$ | 4.77 | Yes | Aug. 01, 2008 | Jan. 12, 2007 |
| Cake Co. B | Cake | $$$ | 4.74 | Yes | Sep. 05, 2008 | Jan. 12, 2007 |
| Cake Co. C | Cake | $$$ | 4.72 | Yes | Sep. 14, 2008 | Jan. 13, 2007 |
| Cake Co. D | Cake | $$$ | 4.65 | No | Sep. 24, 2008 | Jan. 13, 2007 |
| . . . | . . . | . . . | . . . | . . . | . . . | . . . |
| Wedding Dress Co. A | Dress | $$$$ | 4.89 | Yes | Dec. 04, 2007 | Jan. 17, 2007 |
| Wedding Dress Co. B | Dress | $$$$ | 4.81 | Yes | Jan. 29, 2008 | Jan. 20, 2007 |
| Wedding Dress Co. C | Dress | $$$$ | 4.76 | Yes | Jul. 13, 2008 | Jan. 21, 2007 |

TABLE III shows a second portion of a database of information of wedding service providers. This table may include the information or references to where the information is located within a database or data repository. For example, images may be referenced so that a computing system knows where the images are located for look-up and display on a webpage. Also, text or “copy” that describes a wedding service provider's services may be located in the table or remotely located in a text file. The copy may be defined by multiple fields, where different text fields may be positioned in different areas of a webpage of the wedding service provider auditor/presenter. A website address for each of the different wedding service providers may be stored for display on the website of the wedding service provider auditor/presenter or to enable a wedding planner to link to the webpage of the wedding service provider. It should be understood that the information stored in TABLE III may include additional or alternative information. For example, secondary images of each wedding service provider may be stored in a database. It should further be understood that the information stored in TABLE III or any other database that includes information other than investigation information generated by the wedding service provider auditor/presenter may be generated by either the wedding service provider or wedding service provider auditor/presenter.

TABLE III
Wedding Service Provider Presentation Information

| Wedding Service Provider | Address | Primary Image | Copy | Website Address |
|---|---|---|---|---|
| Hotel A | 123 Main St. | Hotel_a_main.gif | Hotel_a_copy.txt | www.hotela.com |
| | Dallas, TX | | | |
| Hotel B | 824 Elm St. | Hotel_b_main.gif | Hotel_b_copy.txt | www.hotelb.com |
| | Dallas, TX | | | |
| Hotel C | 10472 Preston Rd. | Hotel_c_main.gif | Hotel_c_copy.txt | www.hotelc.com |
| | Dallas, TX | | | |
| Hotel D | 143 McKinney Ave. | Hotel_d_main.gif | Hotel_d_copy.txt | www.hoteld.com |
| | Dallas, TX | | | |
| Hotel E | 328 Olive St. | Hotel_e_main.gif | Hotel_e_copy.txt | www.hotele.com |
| | Dallas, TX | | | |
| Hotel F | 777 Ross Ave. | Hotel_f_main.gif | Hotel_f_copy.txt | www.hotelf.com |
| | Dallas, TX | | | |
| Cake Co. A | 743 McKinney Ave. | Cake_a_main.gif | Cake_a_copy.txt | www.hotela.com |
| | Dallas, TX | | | |
| Cake Co. B | 91 Oak Lawn Rd. | Cake_b_main.gif | Cake_b_copy.txt | www.cakeb.com |
| | Dallas, TX | | | |
| Cake Co. C | 1738 Oak Lawn Rd. | Cake_c_main.gif | Cake_c_copy.txt | www.cakec.com |
| | Dallas, TX | | | |
| Cake Co. D | 7438 Cole Ave. | Cake_d_main.gif | Cake_d_copy.txt | www.caked.com |
| | Dallas, TX | | | |
| . . . | . . . | . . . | . . . | . . . |
| Wedding Dress Co. A | 525 Knox St. | Wed_dress_a_main.gif | Wed_dress_a_copy.txt | www.weddressa.com |
| | Dallas, TX | | | |
| Wedding Dress Co. B | 664 Oak Lawn Rd. | Wed_dress_b_main.gif | Wed_dress_b_copy.txt | www.weddressb.com |
| | Dallas, TX | | | |
| Wedding Dress Co. C | 8742 Preston Rd. | Wed_dress_c_main.gif | Wed_dress_c_copy.txt | www.weddressc.com |
| | Dallas, TX | | | |

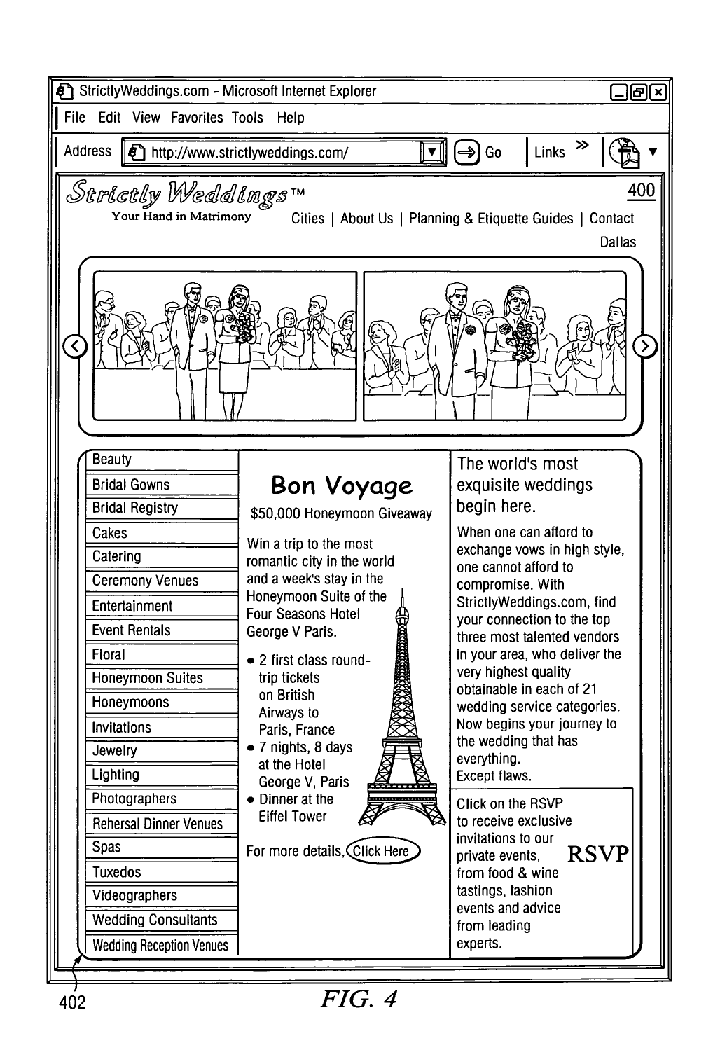

FIG. 4 is a screen shot of an exemplary webpage 400 available for wedding planners to select from a list of wedding planning categories 402 to view wedding service providers. The list of wedding planning categories 402 may be stored in a database and displayed for selection by a wedding planner. The list may include any category that the wedding service provider auditor/presenter decides could be helpful to a wedding planner in planning a wedding. TABLE IV is an exemplary list of wedding planning categories 402 and other and different categories may be provided in accordance with the principles of the present invention. It should be understood that the tables presented herein may be part of a single database or multiple databases that may be relational, flat, or any other database structure to enable the wedding service provider auditor/presenter to associate or relate the information in the tables to make use of the website more easily used by the wedding planners.

TABLE IV
Wedding Planning Categories

| Category | Category |
|---|---|
| Beauty | Jewelry |
| Bridal Gowns | Party Rental |
| Catering | Photographers |
| Cakes | Rehearsal Dinner Venues |
| Ceremony Venues | Spas |
| Gifts | Transportation |
| Entertainment | Tuxedos |
| Floral | Videographers |
| Honeymoons | Wedding Consultants |
| Honeymoon | Wedding Reception Venues |
| Suites | |
| Invitations | |

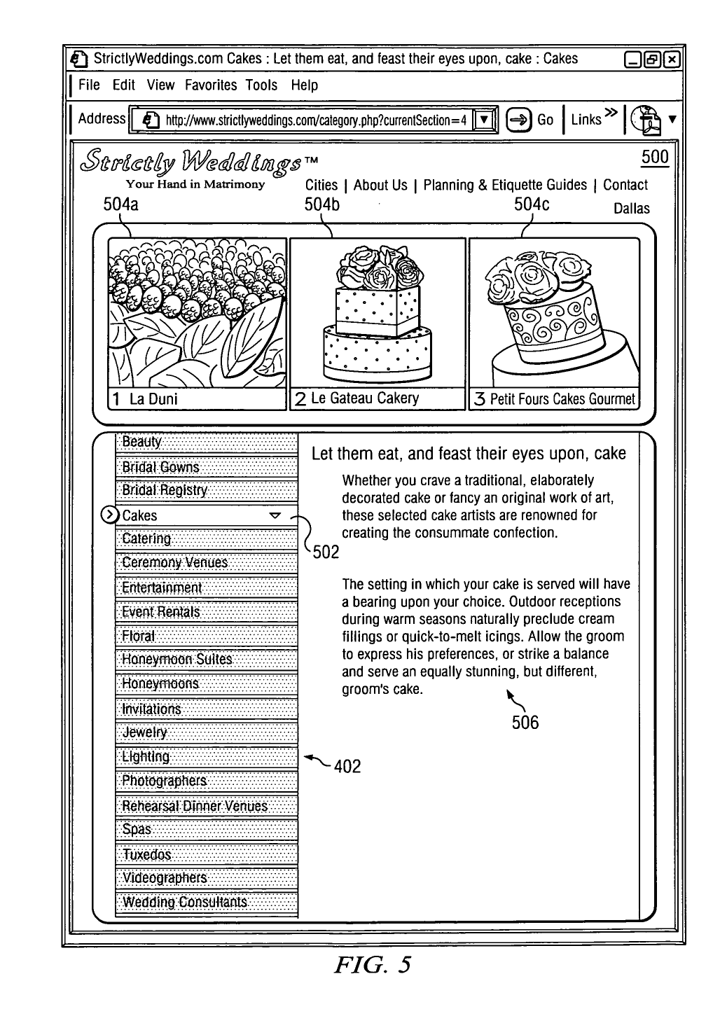

FIG. 5 is a screen shot of an exemplary webpage 500 available for wedding planners to view and select from three wedding service providers. As shown, the webpage 500 may include the list of wedding planning categories 402 and a particular category 502 (e.g., “cakes” category) may be selected by a wedding planner using a conventional selection device. In selecting the particular category 502, images associate with three cake companies may be displayed in three image panes 504a, 504b, and 504c (collectively 504). The images may be photographs, graphics, text, or otherwise to represent the type of product or service provided by the companies selected. Three images of cakes are presented in the three image panes 504 and names of the three companies are shown below the three images. The images within the three image panes 504 may be selectable for a wedding planner to view detailed information about the selected wedding service provider, including a website link to enable the wedding planner to link to the website of the selected wedding service provider. In addition, a description 506 of the category, which may include a price range, may be included on the webpage 500.

In one embodiment, a relative price range selection element (not shown) may be included on the webpage 500 to enable the wedding planner to view wedding service providers within a relative price range. The relative price range selection element may be a drop-down box that shows selectable relative price ranges (e.g., “$$$$,” “$$$,” “$$,” “$”). In one embodiment, each of the wedding planning categories 402 may have a relative price range selection element to enable the wedding planner to individually select a relative price range for each wedding planning category. Alternatively, a selection of a price range for all wedding planning categories may be selected.

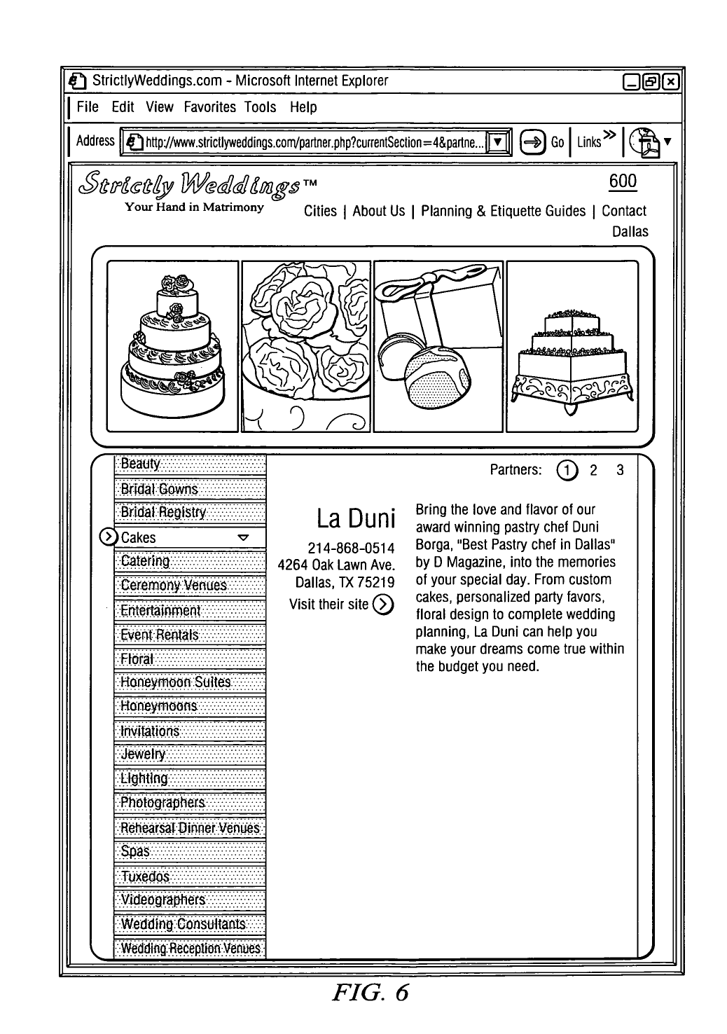

FIG. 6 is a screen shot of an exemplary webpage 600 available for wedding planners to view information of a selected wedding service provider (e.g., “The Cakery Company”). The selected wedding service provider shown in the webpage 600 may be selected by a wedding planner using a pointing device (e.g., computer mouse) or other selection technique, as understood in the art. The webpage 600 may be part of the website provided by the wedding service provider auditor/presenter. Information of the wedding service provider as stored in a database (see, for example, TABLE III). A website link to the selected wedding service provider's website may also be provided to enable the wedding planner to view much more detailed information presented by the wedding service provider.

FIG. 7 is a flow chart of an exemplary process 700 of a wedding service provider auditor/presenter to manage and present information of wedding service providers in accordance with the principles of the present invention. The process 700 may include investigating wedding service providers of a selected service category at step 702. At step 704, at least three of the wedding service providers qualify as meeting a product quality threshold for the selected wedding service category may be determined. Information of three of the wedding service providers for the selected wedding service category may be displayed to enable a wedding planner to select from in planning a wedding at step 706.

Although the description above is directed to planning a wedding, the principles of the present invention may be applied to other applications. For example, planning for birthdays, births, and other festive events may be provided by the principles of the present invention. Still yet, sad events, such as funerals, may also be supported through the use of the system. In one embodiment, rather than using the principles of the present invention for a consumer activity, business activities may be provided, such as starting a business, conducting a meeting, running a trade show or other trade event, etc. For example, for an application of starting a business, the service providers, rather than being wedding service providers, may include lawyers, accountants, marketing companies, advertising companies, healthcare companies, retirement investment companies, and any other categories of business service providers.

It should be understood that while the embodiments present three service providers to be presented, that other limited numbers of service providers, such as four, five, or six, may be determined and displayed to be desired by wedding planners or for any other application. The limited number of service providers may satisfy the same or similar desires of both the wedding service provider auditor/presenter and wedding planners. The wedding service provider auditor/presenter may desire to have a limited number of wedding service providers to ensure quality and maintain demand by wedding service providers to be placed on the website, while wedding planners may desire to have a small enough selection of wedding service providers to be practical in terms of selecting a quality wedding service provider. Ultimately, the wedding service provider auditor/presenter may become an endorser or otherwise give a “stamp or seal of approval” to those wedding service providers (or other types of service providers) who achieve high quality standards to be presented on the website of the limited number of wedding service providers for a particular category.

The previous detailed description is of a small number of embodiments for implementing the invention and is not intended to be limiting in scope. One of skill in this art will immediately envisage the methods and variations used to implement this invention in other areas than those described in detail. The following claims set forth a number of the embodiments of the invention disclosed with greater particularity.

What is claimed:

1. A method of presenting information of wedding service providers to wedding planners, said method comprising:
investigating wedding service providers of a selected wedding service category;
determining that at least three of the wedding service providers qualify as meeting a product quality threshold for the selected wedding service category; and
displaying information of three of the wedding service providers that meet the product quality threshold for the selected wedding service category to enable a wedding planner to select from in planning a wedding.

2. The method according to claim 1, wherein investigating includes visiting premises of each of the wedding service providers.

3. The method according to claim 2, wherein determining that at least three of the service providers qualify as meeting a product quality threshold by reviewing predetermined quality parameters for a type of service being provided by the wedding service providers.

4. The method according to claim 3, wherein reviewing predetermined quality parameters includes assigning a grade to each of the predetermined quality parameters.

5. The method according to claim 4, further comprising determining an average grade of the grades assigned to each predetermined quality parameter.

6. The method according to claim 1, further comprising replacing information of one of the displayed three wedding service providers with information of a wedding service provider determined to qualify as meeting a product quality threshold but not currently being displayed.

7. The method according to claim 1, further comprising limiting display of wedding service providers to geographic regions in which the wedding service providers are located.

8. The method according to claim 1, wherein investigating the wedding service providers for product quality is performed at least one time per year.

9. The method according to claim 8, wherein in response to determining that any of the wedding service providers does not meet the product quality threshold any longer, removing the wedding service providers from a list of the wedding service providers that meet the product quality threshold and, if any of the wedding service providers that are determined not to meet the product quality threshold are being displayed, then removing the information from being displayed.

10. The method according to claim 1, further comprising assigning a relative price range of each of the wedding service providers; and
wherein displaying information of three of the wedding service providers for the selected wedding service category is in response to the wedding planner selecting a relative price range for the selected wedding service category.

11. A system for presenting information of wedding service providers to wedding planners, said system comprising:
a database configured to store information records of a plurality of wedding service providers, the information records including investigation results of the wedding service providers and a wedding service category for which the wedding service providers provide wedding services;
a processing unit in communication with said database, and configured to:
determine that at least three of the wedding service providers stored in said database qualify as meeting a product quality threshold for respective wedding service categories; and
display information records of three of the wedding service providers for a selected wedding service category to enable a wedding planner to select from in planning a wedding.

12. The system according to claim 11, wherein said processing unit is configured to receive the investigation results from an investigator that generates the investigation results by visiting premises of each of the wedding service providers to determine quality of each of the wedding service providers.

13. The system according to claim 12, wherein the investigation results of the wedding service providers include predetermined quality parameters, and wherein said processing unit is further configured to compute an average value of the quality parameters of the wedding service providers.

14. The system according to claim 13, wherein each of the predetermined quality parameters has a grade assigned thereto.

15. The system according to claim 14, wherein said processing unit is further configured to determine an average grade of the grades assigned to each predetermined quality parameter.

16. The system according to claim 11, wherein said processing unit is further configured to replace information of one of the displayed three wedding service providers with information of a wedding service provider determined to qualify as meeting a product quality threshold but not currently being displayed.

17. The system according to claim 11, wherein said processing unit is further configured to limit display of wedding service providers to geographic regions in which the wedding service providers are located.

18. The system according to claim 11, wherein the information records in said database are updated at least one time per year based on continued investigation of the wedding service providers for product quality.

19. The system according to claim 18, wherein said database is updated, in response to determining that any of the wedding service providers does not meet the product quality threshold any longer, to remove the wedding service providers of the wedding service providers that meet the product quality threshold and, if any of the wedding service providers that are determined not to meet the product quality threshold are being displayed, then said processing unit is configured to remove the information from being displayed.

20. The system according to claim 11, wherein said database is further configured to store assigned relative price ranges of each of the wedding service providers; and
wherein said processing unit is further configured to display information of three of the wedding service providers for the selected wedding service category in response to the wedding planner selecting a relative price range for the selected wedding service category.

21. A graphical user interface, comprising:
a list of selectable wedding categories; and
a region in which selectable information of three wedding service providers are displayed in response to a selection of one of the selectable wedding categories.

22. The graphical user interface according to claim 21, wherein each of the three wedding service providers displayed in said region are determined to have a product quality above a product quality threshold.

23. The graphical user interface according to claim 21, wherein in response to a user selecting one of the three wedding service providers being displayed in said region, displaying additional information of the selected wedding service provider.

24. A graphical user interface, comprising:
a list of selectable service provider categories; and
a region in which selectable information of a limited number of service providers are displayed in response to a selection of one of the selectable service provider categories.

25. The graphical user interface according to claim 24, wherein the list of selectable service provider categories are wedding service provider categories, and where the limited number of service providers is three wedding service providers.
